(19) United States
(12) Patent Application Publication
(10) Pub. No.: US 2025/0052919 A1
(43) Pub. Date: Feb. 13, 2025

(54) NOISE-ROBUST TIME-DOMAIN MULTI-SCALE FULL WAVEFORM INVERSION USING CONVOLVED DATA

(71) Applicant: Saudi Arabian Oil Company, Dhahran (SA)

(72) Inventors: Young Seo Kim, Dhahran (SA); Jewoo Yoo, Delft (NL); Hussain J. sALIM, Dhahran (SA)

(73) Assignee: Saudi Arabian Oil Company, Dhahran (SA)

(21) Appl. No.: 18/448,521

(22) Filed: Aug. 11, 2023

(51) Int. Cl. G01V 1/28; G06V 10/25; G06V 20/10

(52) U.S. Cl. CPC G01V 1/282; G06V 10/25; G06V 20/10; G01V 2210/23

(57) ABSTRACT

Systems and methods for noise-robust time-domain multi-scale full waveform inversion using convolved data are disclosed. The methods include obtaining, using a seismic acquisition system, an observed seismic dataset pertaining to a subsurface region of interest; obtaining, using a seismic processor, a seismic velocity model; and iteratively, using the seismic processor, until a stopping criterion is met: selecting a wavelet with a frequency parameter, wherein the frequency parameter increases with each iteration, forming a convolved seismic dataset based on a convolution of the wavelet with the observed seismic dataset, and updating, using a full waveform inversion, the seismic velocity model based, at least in part, on the convolved seismic dataset. The methods further include forming a seismic image of the subsurface region of interest using the updated seismic velocity model.

### BACKGROUND

Full waveform inversion [FWI] attempts to convert raw seismic data, typically obtained by sensors at the surface of the earth but sometimes from sensors located in a borehole, into a model of geophysical properties in the subsurface. In doing so, it attempts to honor the full physics of seismic wave propagation in a heterogeneous medium as codified by a wave equation. In order to reach an accurate solution, FWI begins with a starting model and iteratively adjusts it. Accuracy may be increased by beginning the inversion initially focusing on large scale information (in terms of both low-pass filtered seismic data and a low-wavenumber starting model) and then adding higher-frequency/higher-wavenumber details at each iteration. However, final models of the subsurface obtained with FWI often miss key features. Therefore, methods are needed that can increase the quality of the FWI result.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments are disclosed related to methods for noise-robust time-domain multi-scale full waveform inversion using convolved data. The methods include obtaining, using a seismic acquisition system, an observed seismic dataset pertaining to a subsurface region of interest; obtaining, using a seismic processor, a seismic velocity model; and iteratively, using the seismic processor, until a stopping criterion is met: selecting a wavelet with a frequency parameter, wherein the frequency parameter increases with each iteration, forming a convolved seismic dataset based on a convolution of the wavelet with the observed seismic dataset, and updating, using a full waveform inversion, the seismic velocity model based, at least in part, on the convolved seismic dataset. The methods further include forming a seismic image of the subsurface region of interest using the updated seismic velocity model.

In general, in one aspect, embodiments are disclosed related to a system configured for noise-robust time-domain multi-scale full waveform inversion using convolved data. The system includes a seismic acquisition system, configured to obtain an observed seismic dataset pertaining to a subsurface region of interest. The system further includes a seismic processor that is configured to obtain a seismic velocity model from the observed seismic dataset, and then, iteratively, until a stopping criterion is met: select a wavelet with a frequency parameter, wherein the frequency parameter increases with each iteration, form a convolved seismic dataset based on a convolution of the wavelet with the observed seismic dataset, and update, using a full waveform inversion, the seismic velocity model based, at least in part, on the convolved seismic dataset. The seismic processor is further configured to form a seismic image of the subsurface region of interest using the updated seismic velocity model.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a seismic acquisition system in accordance with one or more embodiments.

FIG. 2 shows a synthetic model of the velocity of the subsurface in accordance with one or more embodiments.

FIG. 3 shows the frequency-domain spectra of a source wavelet, recorded data, and added noise in accordance with one or more embodiments.

FIG. 4 shows a shot gather from a seismic dataset and filtered versions of the shot gather in accordance with one or more embodiments.

FIG. 5 shows an initial velocity model and a conventional FWI in accordance with one or more embodiments.

FIG. 6 shows two stages of multiscale FWI using low-pass filtering of the seismic data in accordance with one or more embodiments.

FIG. 7 shows two stages of multiscale FWI convolving seismic data using a wavelet obtained by taking the first derivative of a Gaussian function in accordance with one or more embodiments.

FIG. 8 shows a flowchart for the multiscale FWI method in accordance with one or more embodiments.

FIG. 9A shows a drilling system in accordance with one or more embodiments.

FIG. 9B shows an interpreted seismic image obtained by using the velocity model output from the multiscale FWI and a migration algorithm along with an interpreted borehole path in accordance with one or more embodiments.

FIG. 10 shows the workflow of a method in accordance with one or more embodiments.

FIG. 11 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

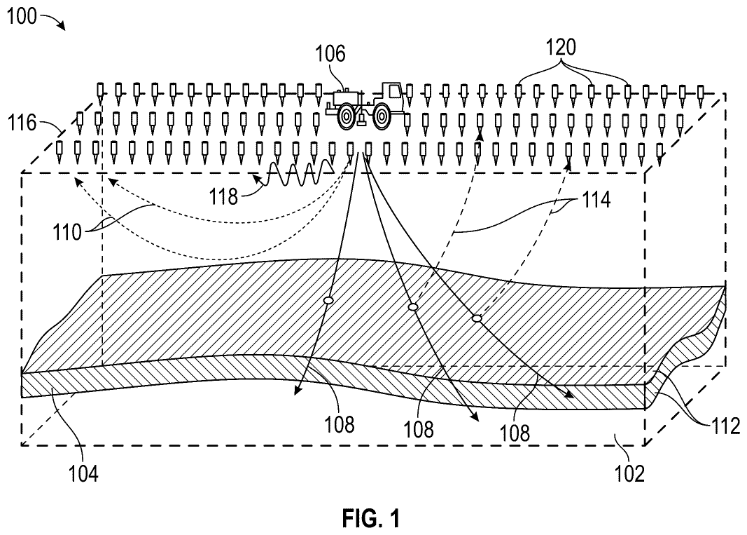

In the following description of FIGS. 1-11, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic dataset” includes reference to one or more of such seismic datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

The systems and methods disclosed herein present an iterative full waveform inversion [FWI] method where observed and modeled seismic data are both convolved with a low-frequency signal whose dominant frequency is increased at each stage. The methods follow a multi-scale FWI approach with the convolution process helping to filter data in a way that is superior to typical frequency-filtering processes, even when the observed seismic data is highly contaminated with noise.

Before further presenting one or more proposed embodiments, the basic elements of a seismic data acquisition are presented for context. A typical method for obtaining a seismic image begins with the design of the seismic data acquisition experiment. This includes selection of a subsurface region of interest due to the presence of hydrocarbons, the type of seismic source used to send waves into the subsurface, the number of sources used, the location of seismic receivers used for each shot, as well as in-field filtering or removal of noisy traces. The geometric relationship of sources and receivers may be influenced by an intended target-perhaps known from another seismic experiment or from well data. To simplify processing, the seismic receivers are often laid out on an orthogonal grid; the sources are placed at points along the same grid. The traces are usually stored according to the shot number, i.e., for each shot, a contiguous portion of memory stores the data recorded by the receivers in some natural ordering, along with headers containing metadata. Seismic data stored in this way are known as a shot gather. Common header information for each seismic trace includes, among other data, the x and y coordinates of both the shots and the receivers.

Once recorded, the seismic data from the field are usually transported to a central processing location that has computational resources to convert them into an image of the subsurface. Migration is an imaging technique that is often used when an accurate velocity model exists. Before migration, the processing workflow often begins with a sorting of the traces. An appropriate sorting can improve the performance of seismic data processing algorithms. One common sorting of seismic data is known as the common midpoint gather (CMP), where seismic traces are grouped together according to a shared midpoint between the shots and receivers. Using 3-D geometric considerations, nonlinear events appearing in CMP gathers can be stacked (i.e., summed) to produce a single trace that delineates geologic structures below each particular midpoint location.

FIG. 1 shows a seismic survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of dry land. The seismic survey (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface of the Earth (116) as refracted seismic waves (110) or may be reflected by geological discontinuities (112) and return to the surface as reflected seismic waves (114). The radiated seismic waves (108) may propagate along the surface as Rayleigh waves or Love waves, collectively known as “ground-roll” (118). Vibrations associated with ground-roll (118) do not penetrate far beneath the surface of Earth (116) and hence are not influenced, nor contain information about, portions of the subterranean region of interest (102) where hydrocarbon reservoirs (104) are typically located. Seismic receivers (120), located on or near the surface of Earth (116), detect reflected seismic waves (114), refracted seismic waves (110) and ground-roll (118).

In accordance with one or more embodiments, the refracted seismic waves (110), reflected seismic waves (114), and ground-roll (118) generated by a single activation of the seismic source (106) are recorded by a seismic receiver (120) as a time-series representing the amplitude of ground-motion at a sequence of discreet sample times. Usually the origin of the time-series, denoted t=0, is determined by the activation time of the seismic source (106). This time-series may be denoted a seismic “trace.” The seismic receivers (120) are positioned at a plurality of seismic receiver locations which we may denote (xᵣ, yᵣ) where x and y represent orthogonal axes on the surface of Earth (116) above the subterranean region of interest (102). Thus, the plurality of seismic traces generated by activations of the seismic source (106) at a single location may be represented as a three-dimensional “3D” volume with axes (xᵣ, yᵣ, t) where (xᵣ, yᵣ) represents the location of the seismic receiver (120) and t denotes the time sample at which the amplitude of ground-motion was measured.

However, a seismic survey (100) may include recordings of seismic waves generated by a seismic source (106) sequentially activated at a plurality of source locations denoted (xₛ, yₛ). In some cases, this may be achieved using a single seismic source (106) that is moved to a new location between activations. In other cases, a plurality of seismic sources (106) positioned at different locations may be used simultaneously. Irrespective of how they are acquired, all the seismic traces acquired by a seismic survey (100) may be represented as a five-dimensional volume, with coordinate axes (xₛ, yₛ, xᵣ, yᵣ, t), and called a “seismic dataset.”

There exist many techniques for processing a seismic dataset to produce an image of the subsurface. The method of interest here is FWI, which attempts to find a model of the earth (typically, a velocity model) that matches the observed seismic data, including multiply scattered waves. Systems and methods focus on implementing FWI in the presence of noisy data by defining one or more objective functions that must be minimized to find the best-fitting model. The one or more embodiments presented here teach performing the convolution of a function with the modeled and observed seismic datasets, and then minimizing a measure of magnitude of the resulting difference between them. A scale-dependent objective function Eᵢ may be a squared l₂-norm of the residuals between the modeled signal and the observed data, where both have been convolved with an arbitrary source signature fᵢ:

$${E}_{i} = {\sum }_{n s} {\sum }_{n r} \int {‖ {f}_{i} ⋆ u − {f}_{i} ⋆ d ‖}_{2}^{2} dt , \qquad ( 1 )$$

where ns and nr are the number of sources and receivers, respectively. u and d are the modeled and observed seismic data, respectively. The symbol * denotes a convolution operation. This choice of the measure of magnitude as a squared l₂-norm does not limit the scope of the system and methods presented here. Any other measure of magnitude may be applied after convolving the observed and modeled seismic datasets with fᵢ. For instance, the measure of magnitude may also be a general lₚ-norm to the p power, a Sobolev norm (which includes spatial derivatives of the seismic datasets, thus enforcing smoothness), or a Besov norm (usually defined by operations on wavelet-domain coefficients).

When the source wavelet and Green's function are presented explicitly, the misfit function in Eqn. 1 for the example of a squared l₂-norm can be expressed as follows:

$${E}_{i} = {\sum }_{n s} {\sum }_{n r} \int ‖ {s}_{u} ⋆ {g}_{u} − {f}_{i} ⋆ {s}_{d} ⋆ {g}_{d} {‖}_{2}^{2} dt , \qquad ( 2 )$$

where s and g are source wavelet and Green's function corresponding to u and d, respectively. In this case, sᵤ≈fᵢ*s_{d}. Since the true source wavelet, s_{d}, is not known exactly, sᵤ only approximates fᵢ*s_{d}. A separate source estimation process aims to recover the convolved source wavelet fᵢ*s_{d}.

Since all functions in the objective function must be discretized to solve on a computer, Eqn. 2 may be represented as:

$${E}_{i} = {\sum }_{n s} {\sum }_{n r} \int ‖ {u}_{i}^{′} ( m ) - {d}_{i}^{′} {‖}_{2}^{2} dt , \qquad ( 3 )$$

where uᵢ′, m, and dᵢ′ are discrete vectors. Solution for the optimal model parameters of Eqn. 3 is then accomplished by finding the inflection point of Eᵢ with respect to the model parameters, m, i.e., a local minimum. Here, this is done by taking derivatives of the objective function with respect to the model parameters and setting the result equal to zero:

$$\frac{\partial {E}_{i}}{\partial m} = {\sum }_{n s} {\sum }_{n r} \int \frac{\partial {u}_{i}^{′}}{\partial m} {‖ ( {u}_{i}^{′} ( m ) − {d}_{i}^{′} ) ‖}_{2}^{2} dt = 0. \qquad ( 4 )$$

Embodiments of the method presented here start fᵢ as a low-frequency signal and progress to higher and higher frequency signals (the subscript, i, is over the set of center frequencies of the convolution wavelet). Since the convolution implementation is easily developed in frequency domain, this multiscale FWI approach may be more efficient to operate there than in the time domain. However, this multiscale FWI method may be applied in the time domain, as well.

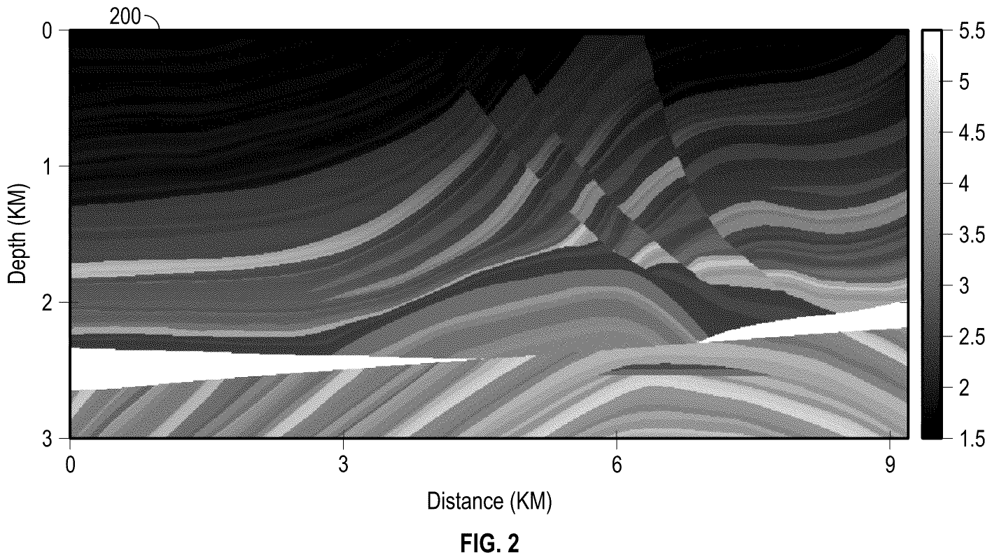

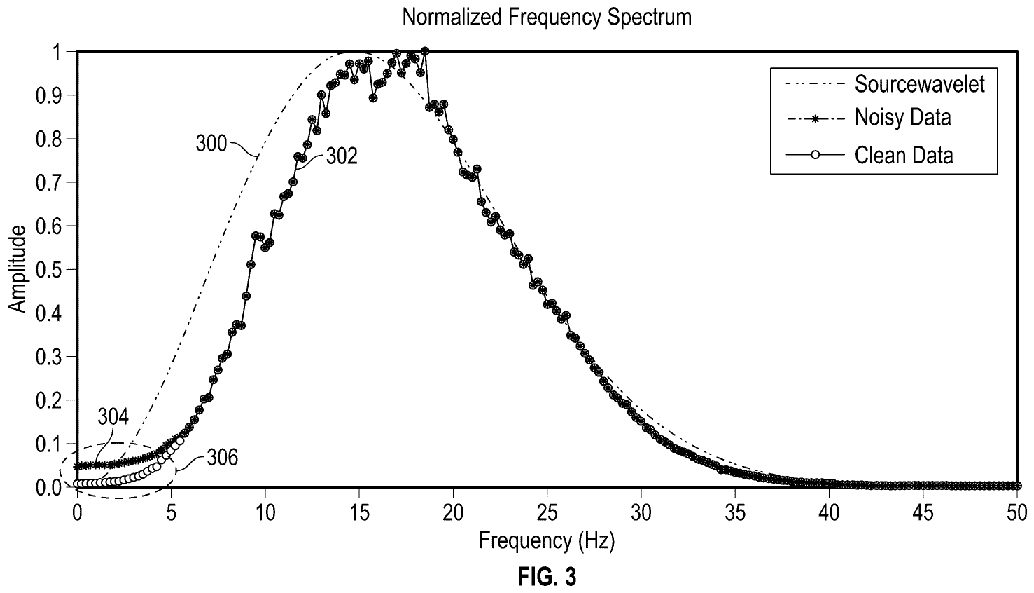

To validate the method, a synthetic seismic dataset may be generated for the Marmousi model (200), shown in FIG. 2, via a time-domain finite-difference modeling algorithm and using a Ricker seismic source wavelet, Sa. In this case, the Ricker wavelet (302) has a maximum frequency 40 hertz (“Hz”) and a dominant frequency of 15 Hz is used, as shown by Ricker wavelet spectrum (300) in the frequency domain in FIG. 3. The medium's response to the Ricker wavelet (302) recorded at a geophone shows the loss of low-frequency information. Noise may be added at low frequencies (in this case, below 7 Hz), as shown by the extended low-frequency tail (304). Normalized frequency amplitudes spectrums of synthetic seismic data with and without noise are shown in FIG. 3. (Noise is located in the circled region (306) on the lower left.)

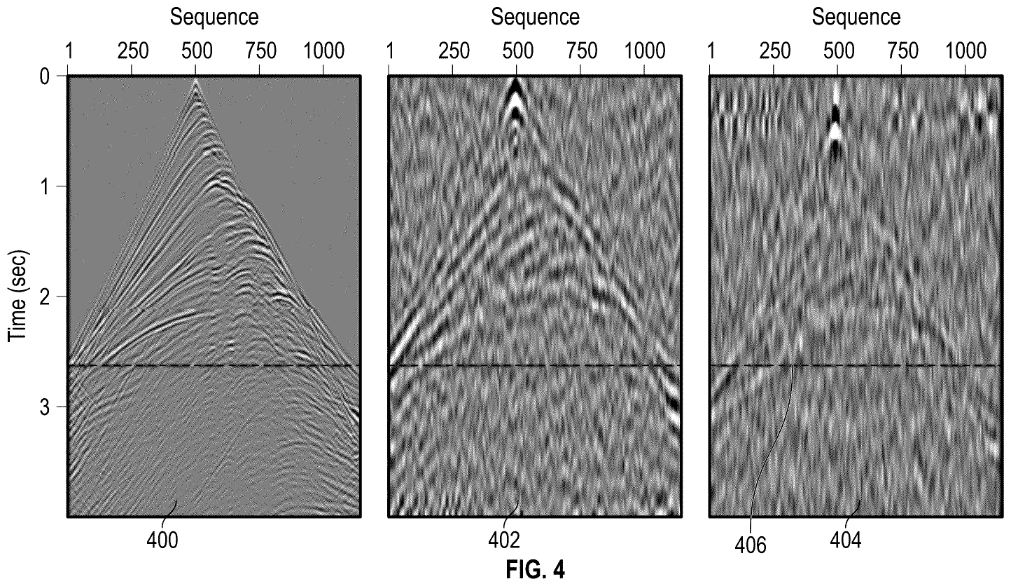

A synthetic raw shot gather obtained from the Marmousi model using the high-frequency Ricker source wavelet, s_{d}, is shown on the left panel (400) of FIG. 4. The middle panel (402) shows the same seismic data after low-pass filtering below 6 Hz. The right panel (404) of FIG. 4 shows the shot gather after convolution with one of the convolutional filters, fᵢ, in this case, the first derivative of a Gaussian function [FDGAUS] with maximum frequency of 6 Hz. The horizontal axis of each panel represents offset along the surface of the Earth. The vertical axis of each panel represents two-way traveltime. White noise for low frequency components below 7 Hz is added to the middle panel (402) and the right panel (404) to make both the synthetic data and the corresponding FWI more realistic.

The main difference between the low-pass filtered seismic data in the middle panel (402) and the FDGAUS-convolved seismic data in the right panel (404) is that the FDGAUS-convolved seismic data in the right panel (404) contains non-zero phase information at the low-frequencies and a different amplitude spectrum. The wavelet used in the FDGUS-convolved seismic data in the right panel (404) is more compact and the resulting filtered seismic data is less prone to oscillations compared to the low-pass filtered seismic data in the middle panel (402). Furthermore, the first arrival signal is delayed with respect to the phase change (see the dashed line (406) across the left panels (400), the middle panel (402), and the right panel (404) in FIG. 4).

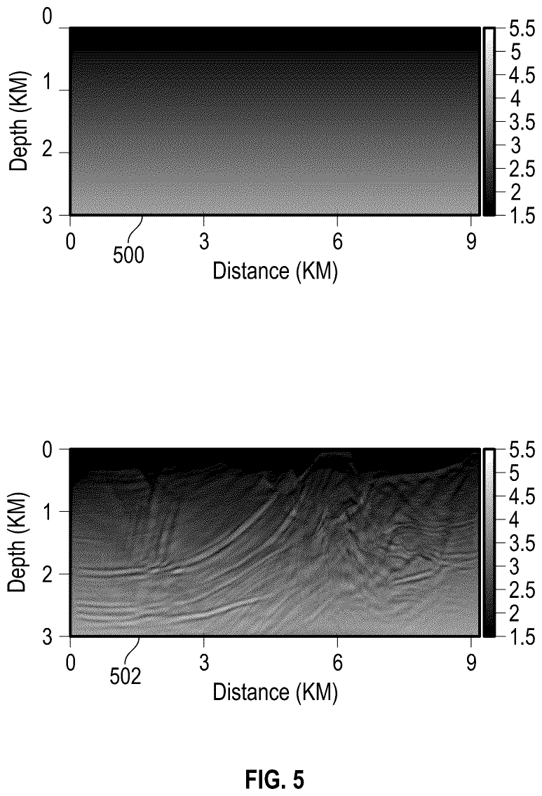

The effectiveness of the one or more embodiments presented of this invention are demonstrated by comparing three different FWI experiments. All the experiments begin with an initial velocity model that increases linearly with depth (500) from 1.5 km/s to 4.0 km/s as shown in FIG. 5. The first experiment performs a conventional time-domain FWI (502). This conventional time-domain FWI (502) converges to a local minimum due the lack of low frequencies in the observed seismic dataset. The nature of the local minimum may be seen by comparing FIG. 5 with FIG. 2 (the true solution). FIG. 5 correctly identifies the general trend of velocities increasing with depth (obtained from the starting model), as well as major reflectors, but misses, e.g., the unconformity at around 2 km depth.

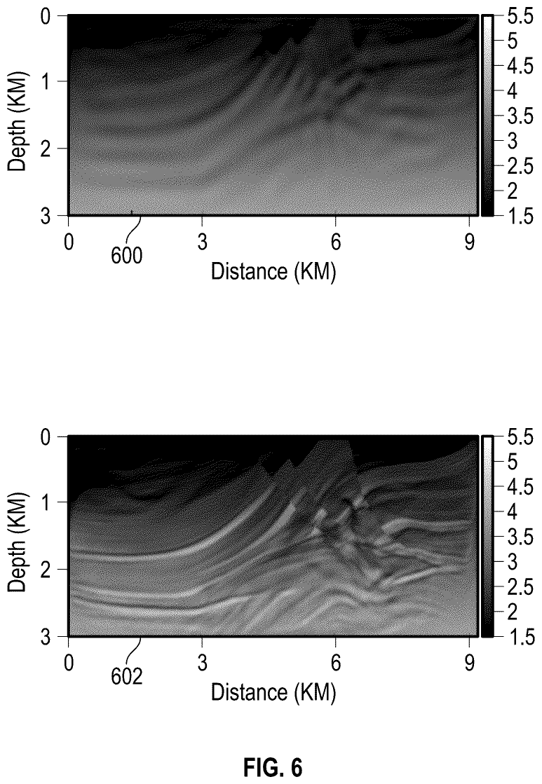

The second experiment is a multiscale FWI in the time domain using a low-pass filtered seismic dataset. In this case, four different datasets are prepared using high-frequency cutoffs at 6 Hz, 9 Hz, 15 Hz, and 20 Hz, along with a fifth seismic data set that is full-band (no filtering). A multiscale FWI proceeds by passing the inversion result of the previous stage on to the next stage as its starting velocity model. Results are shown in FIG. 6 at the first stage for a 6 Hz low-pass FWI (600) and at the final stage for a full band FWI (602). The FWI result with low-pass filtered 6 Hz recovers the large-scale velocity structure well. Moreover, the final-stage FWI result shows a significantly improved model when compared with the first-stage result. However, there are large mismatches in the result, especially for the high-velocity regions in the deeper parts.

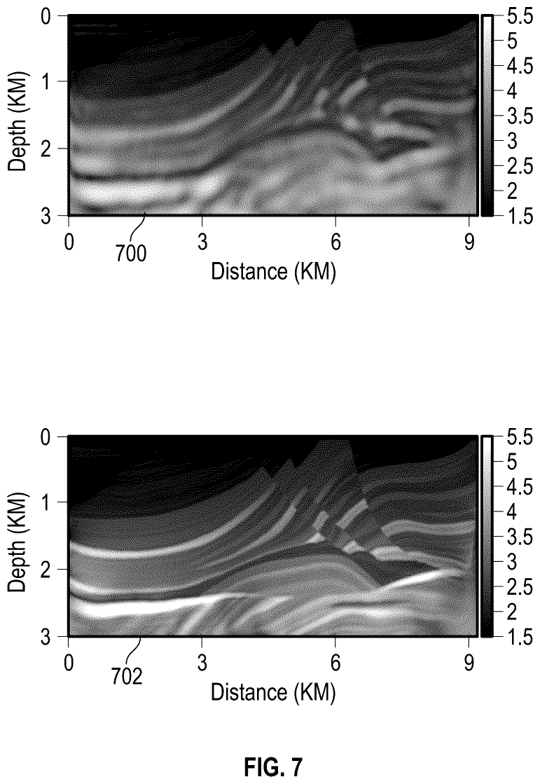

FIG. 7 shows results from the third experiment, an embodiment of this invention, which is also a multiscale procedure. This time, however, the seismic dataset is convolved with the signal fᵢ (the first derivative of a Gaussian function [FDGAUS]) with maximum frequencies of 6 Hz, 9 Hz, 15 Hz, and 20 Hz. As before, the inversion result from each stage is passed on to the next stage as an initial model, and the final stage is a full-band FWI (i.e., no convolution with fᵢ). Results are shown at the first stage for the 6 Hz FDGAUS FWI (700) and at the final stage for a full-band FDGAUS FWI (702). It may be seen that the full-band FDGAUS FWI (702) has produced the most detail in the inversion result and is closest to the Marmousi model (200). The first stage reveals large-scale structures of the Marmousi model (200) while still being contaminated with low-frequency noise. The third stage result corrects for the contamination and successfully recovers most features of the Marmousi model (200), including the unconformity at 2 km depth.

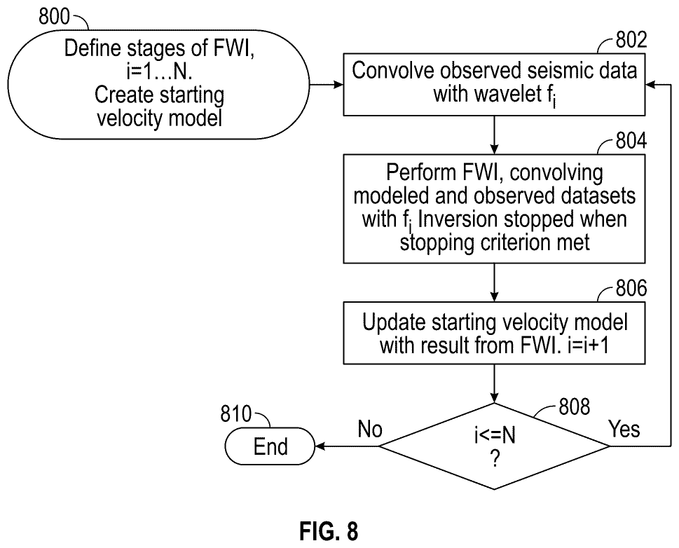

FIG. 8 presents a flowchart in accordance with one or more embodiment of the multiscale FWI algorithm presented in this invention. At Step 800, and embodiment of the method of this invention begins by setting a counter defining the number of stages to perform the multiscale inversion. Each stage corresponds to a convolution with a wavelet of a differing characteristic frequency, such as a peak frequency or a maximum frequency, with the characteristic frequency of the i-th stage being greater than the characteristic of the (i−1)-th stage. In Step 800, the initial velocity model for the first stage is also constructed. In some embodiments, the initial velocity model may be the best available approximation to the true velocity model, such as a velocity model obtained from ray-based tomographic velocity analysis. In other embodiments, the initial velocity model may be a simple one-dimensional velocity model, such as the initial velocity model that increases linearly with depth (500).

In Step 802, the FDGAUS wavelet for the current stage is convolved with the observed seismic dataset. The use of the FDGAUS wavelet is not a limitation of this invention. Any other wavelet may be used, such as, e.g., a Ricker wavelet (302) or an Ormsby wavelet. The choice of wavelet will depend on the characteristics of the seismic data and of the wavelet, as well as the knowledge of seismic data processing possessed by a person of ordinary skill in the art.

In Step 804, FWI is performed with the convolved seismic data. At each stage the observed seismic data and the modeled seismic data are convolved with the same wavelet. This common wavelet changes between one stage and the next. Iterations of the FWI continue until a predetermined stopping criterion is met. (Iterations are steps of the optimization algorithm underlying the FWI at each stage of the workflow.) The optimization may be a gradient-based method, a steepest descent method, or any other optimization method known to a person of ordinary skill in the art. The stopping criterion of the iterations may be a convergence criterion, where the objective function falls below a predetermined level. The stopping criterion may also be a stagnation criterion, where the objective function stops decreasing at a predetermined significance level. The stopping criterion may also be a predetermined maximum number of iterations. These choices of stopping criteria do not limit the scope of the invention; other stopping criteria may also be used.

In Step 806, the previous starting velocity model is updated with the output of the FWI. The velocity model output from one stage of the multiscale FWI may be further manipulated by a subject matter expert before inputting to the next stage. This allows a priori information and expert information to be added to the workflow. At Step 806, the counter is also increased by one.

At Step 808, the counter is checked to see if it is less than or equal to N, the maximum number of stages. If it is less than or equal to N, the flowchart returns to Step 802. If the counter is greater than N, the flowchart proceeds to Step 810, where it terminates.

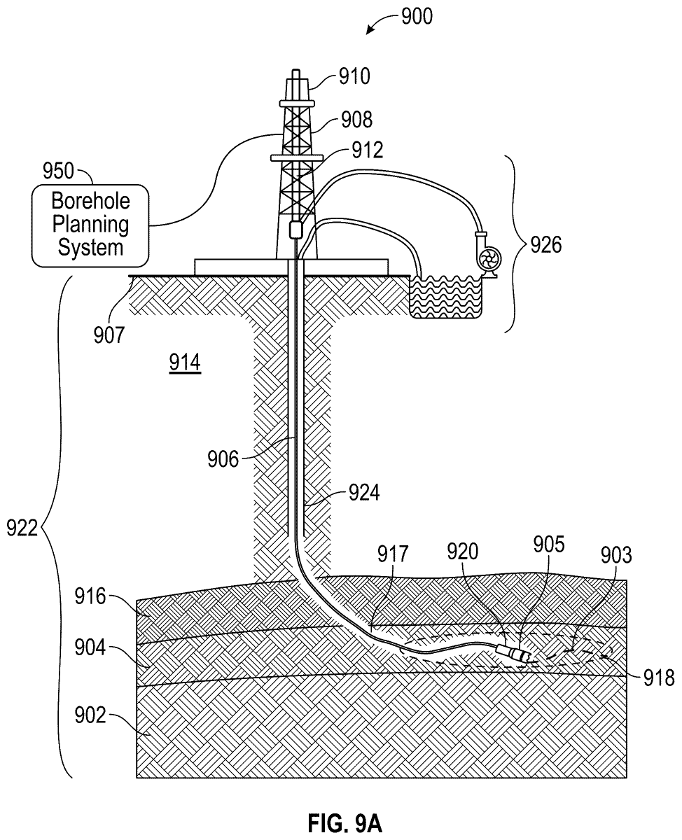

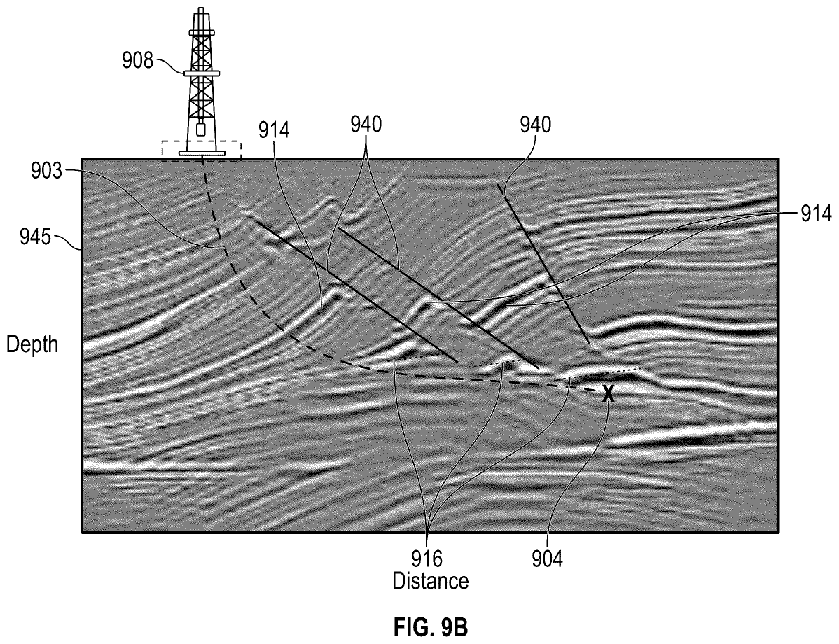

FIG. 9A presents a borehole drilling system. Its components is essential for understanding an application of the present invention. FIG. 9A presents these elements in accordance with one or more embodiments. As shown in FIG. 9A, a borehole path (903) may be drilled by a drill bit (905) attached by a drillstring (906) to a drill rig located on the surface (907) of the earth. Although the drilling system (900) shown in FIG. 9A is used to drill a borehole (917) on land, the drilling system (900) may also be a marine borehole drilling system. The example of the drilling system (900) shown in FIG. 9A is not meant to limit the present disclosure. The drill rig may include framework, such as a derrick (908), to hold drilling machinery. The top drive (910) sits at the top of the derrick (908) and provides torque, typically a clockwise torque, via the drive shaft (912) to the drillstring (906) in order to drill the borehole (917). The borehole (917) may traverse a plurality of overburden (914) layers and one or more cap-rock (916) layers to a hydrocarbon reservoir (904) within the subterranean region of interest (902). In accordance with one or more embodiments, the extended bandwidth seismic dataset may be used to plan a borehole (917) including a borehole path (903) and drill a borehole (917) guided by the borehole path (903). The borehole path (903) may be a curved borehole path or a straight borehole path. All or part of the borehole path (903) may be vertical, and some borehole paths (903) may be deviated or have horizontal sections.

Prior to the commencement of drilling, the borehole plan may be generated. The borehole plan may include a starting surface (907) location of the borehole (917), or a subsurface location within an existing borehole (917), from which the borehole (917) may be drilled. Further, the borehole plan may include a terminal location that may intersect with the target zone (918), e.g., a targeted hydrocarbon-bearing formation and a planned borehole path (903) from the starting location to the terminal location. In other words, the borehole path (903) may intersect a previously located hydrocarbon reservoir (904).

A borehole planning system (950) may be used to generate the borehole plan. The borehole planning system (950) may comprise one or more computer processors in communication with computer memory containing the geophysical and geomechanical models, the extended bandwidth seismic dataset, information relating to drilling hazards, and the constraints imposed by the limitations of the drillstring (906) and the drilling system (900). The borehole planning system (950) may further include dedicated software to determine the planned borehole path (903) and associated drilling parameters, such as the planned borehole diameter, the location of planned changes of the borehole diameter, the planned depths at which casing (924) will be inserted to support the borehole (917) and to prevent formation fluids entering the borehole (917), and the drilling mud weights (densities) and types that may be used during drilling the borehole (917).

A borehole (917) may be drilled using a drill rig that may be situated on a land drill site, an offshore platform, such as a jack-up rig, a semi-submersible, or a drill ship. The drill rig may be equipped with a hoisting system, such as a derrick (908), which can raise or lower the drillstring (906) and other tools required to drill the well. The drillstring (906) may include one or more drill pipes connected to form a conduit and a BHA (920) disposed at the distal end of the drillstring (906). The BHA (920) may include a drill bit (905) to cut into subsurface (922) rock. The BHA (920) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (905), the WOB, and the torque. The LWD measurements may include sensors, such as resistivity, gamma ray, and neutron density sensors, to characterize the rock formation surrounding the borehole (917). Both MWD and LWD measurements may be transmitted to the surface (907) using any suitable telemetry system, such as mud-pulse or wired-drill pipe, known in the art.

The near surface is typically made up of loose or soft sediment or rock, so large diameter casing (924), e.g., “base pipe” or “conductor casing,” is often put in place while drilling to stabilize and isolate the borehole (917). At the top of the base pipe is the wellhead, which serves to provide pressure control through a series of spools, valves, or adapters. Once near-surface drilling has begun, water or drilling fluid may be used to force the base pipe into place using a pumping system until the wellhead is situated just above the surface (907) of the earth.

Drilling may continue without any casing (924) once deeper, or more compact rock is reached. While drilling, a drilling mud system (926) may pump drilling mud from a mud tank on the surface (907) through the drill pipe. Drilling mud serves various purposes, including pressure equalization, removal of rock cuttings, and drill bit (905) cooling and lubrication.

At planned depth intervals, drilling may be paused and the drillstring (906) withdrawn from the borehole (917). Sections of casing (924) may be connected and inserted and cemented into the borehole (917). Casing string may be cemented in place by pumping cement and mud, separated by a “cementing plug,” from the surface (907) through the drill pipe. The cementing plug and drilling mud force the cement through the drill pipe and into the annular space between the casing (924) and the borehole wall. Once the cement cures, drilling may recommence. The drilling process is often performed in several stages. Therefore, the drilling and casing cycle may be repeated more than once, depending on the depth of the borehole (917) and the pressure on the borehole walls from surrounding rock.

A drilling system (900) may be disposed at and communicate with other systems in the well environment. The drilling system (900) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure WOB, drill RPM, flow rate of the mud pumps (GPM), and ROP of the drilling operation. Each sensor may be positioned or configured to measure a desired physical stimulus. Drilling may be considered complete when a target zone (918) is reached, or the presence of hydrocarbons is established.

Given the above review of a drilling system, FIG. 9B shows an application of the results of the methodology of the current invention. The final seismic velocity model resulting from the multiscale FDGAUS-convolved FWI may be used to create a seismic image using seismic migration. The migration algorithm may be based on the velocity model output from the multiscale FDGAUS-convolved FWI method, and produce a more detailed, higher-resolution image (945) than the final velocity model output from the multiscale FWI, hence aiding interpretation of the subsurface. This migrated image may subsequently be used to delineate geological features such as faults (940) and stratigraphic overburden (914) and caprock (916) layers, and then plan a borehole path (903) to intersect a drilling target in a hydrocarbon reservoir (904) from a derrick (908) to access hydrocarbons located in the hydrocarbon reservoir (904).

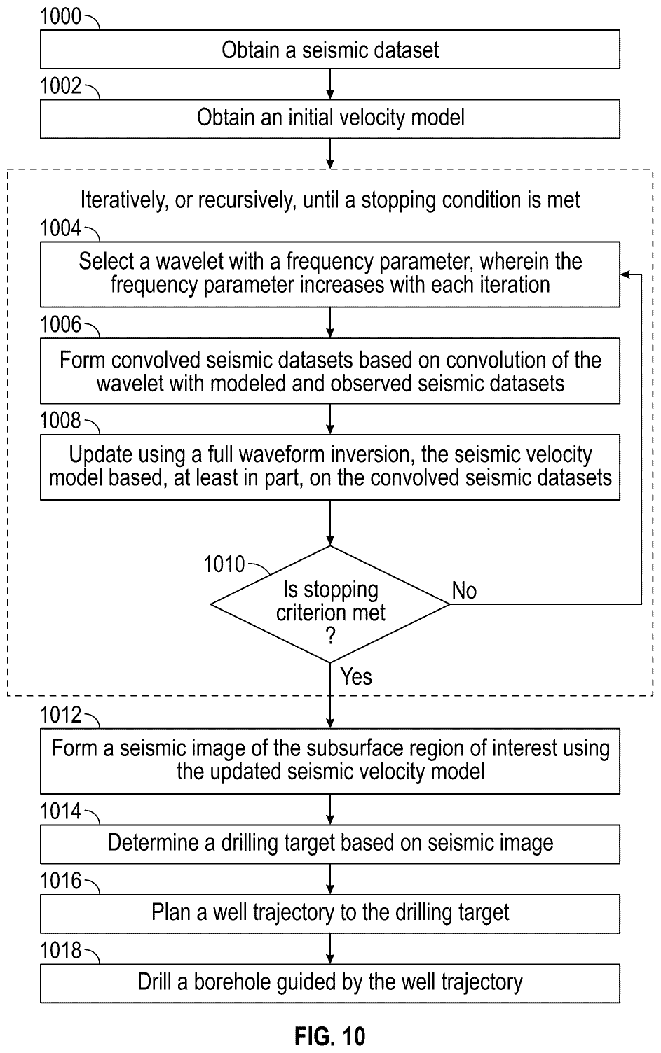

FIG. 10 presents the workflow in accordance with one or more embodiments, including application to the discovery of hydrocarbons. In Step 1000, a seismic dataset may be obtained for a subterranean region of interest (102). The subterranean region of interest (102) may be a region where hydrocarbons are believed to exist in the subsurface, a frontier exploration region, or another region of interest.

In Step 1002, an initial velocity model may be obtained. In some embodiments the initial velocity mode may exhibit a linear increase in velocity with depth. In other embodiments, the initial velocity model may be a constant velocity model. In general, however, the initial velocity model may exhibit any form of spatial dependency with departing from the scope of the invention. The closer this initial model is to the true solution, the better the FWI will perform at each stage. Frequently, the initial velocity model may be obtained from the seismic data using any less costly and more approximate form of velocity analysis known to one of ordinary skill in the art.

In Step 1004, a plurality of wavelets may be created, one for each stage of the multiscale inversion. In some embodiments, the wavelet may be a first derivative of a Gaussian function (FDGAUS) wavelet, but other types of wavelet, such as Ricker or Ormsby wavelet may also be used without departing form the scope of the invention.

In Step 1006, at each stage of the multiscale inversion, one of the plurality of wavelets is convolved with the observed seismic dataset. The same wavelet is convolved with modeled seismic data at each iteration of the FWI, as well.

In Step 1008, a FWI may be performed. The FWI may find an extremum of an objective function. In some embodiments the extremum may be a minimum while in other embodiments the extremum may be a maximum. The FWI may find an extremum of an objective function based on convolved modeled seismic dataset and the convolved observed seismic dataset. At each iteration the FWI method modifies the velocity model so that it produces a convolved modeled seismic dataset that matches the convolved observed seismic dataset to a tolerance level specified by a stopping criterion.

In Step 1010, the stopping criterion may be checked. If the stopping criterion is satisfied the method proceeds to Step 1012. If the stopping condition is not satisfied, the method may return to Step 1004 to repeat the iterative loop. The output velocity model from one stage of the FWI may be used as the initial velocity model for the subsequent stage of the multiscale inversion.

In Step 1012, the final output velocity model from the last stage of the multiscale FWI is used to produce an image of the subsurface. The image may be produced with a depth migration algorithm, but other methods of imaging may be used as well.

In Step 1014, the seismic image may be used to interpret the subsurface, identify the location of hydrocarbons. In Step 1016, a well path may be planned for a drilling operation. In Step 1018, a borehole may be drilled, guided by the planned well path.

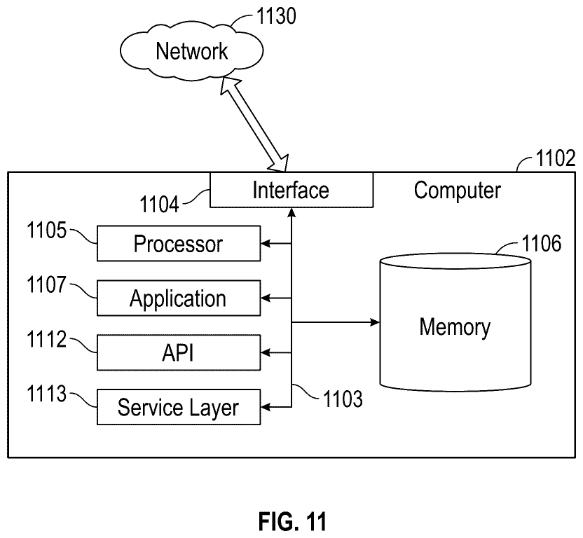

FIG. 11 depicts a block diagram of a computer system (1102) used to provide computational functionalities associated with described algorithms, methods, functions, processes, flows, and procedures as described in this disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102)) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113)). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures.

What is claimed is:

1. A method, comprising:
obtaining, using a seismic acquisition system, an observed seismic dataset pertaining to a subsurface region of interest;
obtaining, using a seismic processor, a seismic velocity model;
iteratively, using the seismic processor, until a stopping criterion is met:
selecting a wavelet with a frequency parameter, wherein the frequency parameter increases with each iteration,
forming a convolved seismic dataset based on a convolution of the wavelet with the observed seismic dataset, and
updating, using a full waveform inversion, the seismic velocity model based, at least in part, on the convolved seismic dataset; and
forming a seismic image of the subsurface region of interest using the updated seismic velocity model.

2. The method of claim 1, further comprising:
determining a drilling target based, at least in part, on the seismic image; and
planning, using a well planning system, a borehole path to intersect the drilling target.

3. The method of claim 2, further comprising drilling, using a drilling system, a borehole guided by the borehole path.

4. The method of claim 1, wherein the wavelet is determined from the observed seismic dataset.

5. The method of claim 1, wherein the wavelet is a first derivative of a Gaussian function.

6. The method of claim 1, wherein the frequency parameter is a maximum frequency.

7. The method of claim 1, wherein obtaining the seismic velocity model comprises initializing a seismic velocity to increase linearly with depth.

8. The method of claim 1, wherein the full waveform inversion minimizes an objective function.

9. The method of claim 8, wherein the objective function is a squared l₂-norm.

10. The method of claim 1, wherein the wavelet is selected based on phase and amplitude information.

11. A system, comprising:
a seismic acquisition system, configured to obtain an observed seismic dataset pertaining to a subsurface region of interest; and
a seismic processor, configured to:
obtain a seismic velocity model from the observed seismic dataset,
iteratively, until a stopping criterion is met:
select a wavelet with a frequency parameter, wherein the frequency parameter increases with each iteration,
form a convolved seismic dataset based on a convolution of the wavelet with the observed seismic dataset, and
update, using a full waveform inversion, the seismic velocity model based, at least in part, on the convolved seismic dataset, and
form a seismic image of the subsurface region of interest using the updated seismic velocity model.

12. The system of claim 11, further comprising:
a well planning system, configured to plan a borehole path to intersect a drilling target; and
a drilling system, configured to drill a borehole guided by the borehole path.

13. The system of claim 11, wherein the wavelet is determined from the observed seismic dataset.

14. The system of claim 11, wherein the wavelet is a first derivative of a Gaussian function.

15. The system of claim 11, wherein the frequency parameter is a maximum frequency.

16. The system of claim 11, wherein a migration algorithm is used to form the seismic image.

17. The system of claim 11, wherein the seismic velocity model is initialized to increase linearly with depth.

18. The system of claim 11, wherein the full waveform inversion minimizes an objective function.

19. The system of claim 18, wherein the objective function is a squared l₂-norm.

20. The system of claim 11, wherein the wavelet is selected based on phase and amplitude information.
